(19) United States
(12) Patent Application Publication
(10) Pub. No.: US 2016/0342991 A1
(43) Pub. Date: Nov. 24, 2016

(54) METHODS AND SYSTEMS FOR PERFORMING AN ECOMMERCE TRANSACTION AT A PHYSICAL STORE USING A MOBILE DEVICE

(71) Applicant: OmnyPay Inc., San Francisco, CA (US)

(72) Inventors: Ashok Narasimhan, San Francisco, CA (US); Mohammad Khan, San Jose, CA (US); William N. Melton, San Francisco, CA (US)

(21) Appl. No.: 15/161,219

(22) Filed: May 21, 2016

Related U.S. Application Data
(60) Provisional application No. 62/165,883, filed on May 22, 2015.

(51) Int. Cl. G06Q 20/40; G06Q 20/32; G06Q 20/10

(52) U.S. Cl. CPC G06Q 20/409; G06Q 20/102; G06Q 20/322

(57) ABSTRACT

According to one aspect, the subject matter described herein includes a system for generating and completing an ecommerce transaction at a physical store. The system includes a database for storing and maintaining payment information for mobile users. A mobile backend server receives, from a mobile device of a user, information identifying a physical store transaction terminal; requests and receives from the identified physical store transaction terminal, information about a transaction desired by the user, the information including an amount of the transaction; forwards the information about the transaction to the user's mobile device for approval by the user; receives, from the user's mobile device, approval from the user to perform the desired transaction; and, in response to receiving the approval, retrieves payment information associated with the user from the database and forwards at least some of the payment information to a payment network for initiating the desired transaction.

### RELATED APPLICATIONS

This application claims the benefit of provisional patent application Ser. No. 62/165,883, filed May 22, 2015, the disclosure of which is hereby incorporated herein by reference in its entirety.

### TECHNICAL FIELD

This disclosure relates to performing secure financial and non-financial electronic transactions made by consumers. More specifically, it relates to methods and systems for performing an ecommerce transaction at a physical store using a mobile device.

### BACKGROUND

Since the advent of credit cards, there has always been the risk that one party in a credit transaction, such as the seller of goods or services, will not receive payment for the received goods or services from the buyer, e.g., that the buyer will default or otherwise refuse to pay. This financial risk has traditionally been borne by the issuing bank. To offset this cost, payment networks such as Visa® and MasterCard® require the acquiring bank, which acts on behalf of the merchant, to pay what is called the “interchange rate” to the issuing bank. The interchange rate was traditionally decided by the payment network. For many years the interchange rate was the source of substantial profits to the payment network, at the cost to the merchants, who had no control over the rate.

When the debit card was introduced, the rationale for imposing the interchange rate became questionable. Debit transactions were successful only if there were sufficient funds in the issuing bank and denied otherwise—so what was the risk? When the “signature debit” card was invented (like a debit card, but did not require entry of a PIN into the point of sale terminal), the question became more pointed: why do the payment networks charge the same interchange rate for a debit transaction (the “debit exchange rate”) as they charge for the much riskier credit transaction (the “credit exchange rate”)?

In addition, for both debit cards and credit cards, interchange rates for “card not present” (CNP) transactions were traditionally higher than interchange rates for “card present” (CP) transactions. Unlike CP transactions, such as swiping a magnetic stripe debit card at a POS terminal, which require actual possession of the card, CNP transactions are more easily spoofed because actual possession of the card is not required. In one type of CNP transaction—an ecommerce transaction—the card information was typically entered into a web page manually. Because possession of an actual card is not mandatory to perform an ecommerce transaction, ecommerce transactions (as well as other CNP transactions, such as “provide the card data to the ecommerce retailer verbally over the phone”) were charged a higher interchange rate.

In 2010, the United States congress enacted Federal law that made several changes to the operation of the payment networks, including handing control of the debit exchange rate over to the Federal Reserve and capping the debit interchange at 0.05 percent plus twenty-one U.S. cents. The credit interchange rate remained under the control of the payment networks. Another change was that for signature debit cards, CNP charges cannot be higher than CP charges. Yet another change was that merchants are allowed to provide incentives to customers to use an alternative method or payment type, including providing incentives to customers to use a payment type that is less expensive for the merchant or otherwise preferred by the merchant.

Unfortunately, however, the traditional payment networks have no incentive to make available to merchants the benefits provided under the law. Accordingly, there is a need to provide these benefits to merchants. More specifically, there is a need to provide methods and systems for performing an ecommerce transaction at a physical store using a mobile device. Furthermore, there is a need to provide merchants with the ability to provide incentives to customers to use an alternative or merchant-preferred payment type.

### SUMMARY

The subject matter disclosed herein includes methods and systems for performing an ecommerce transaction at a physical store using a mobile device. The subject matter disclosed herein also includes methods and systems for merchants to provide incentives to customers to use an alternative or merchant-preferred payment type.

According to one aspect, the subject matter described herein includes a method for authenticating a mobile user for ecommerce transactions. The method includes, at a mobile backend server for storing and maintaining payment information for mobile users, receiving, from a mobile user, information associated with a payment card, the information including a billing address and a card security code, and performing an authentication only reversible transaction for a nominal amount using an ecommerce format. If the transaction is approved, the method includes storing the information except for the card security code, associating the mobile user to the stored information, and authenticating the combination of the mobile user and the stored information for ecommerce transactions. In one embodiment, the mobile user and payment information may be authenticated not only to each other but also to a specific mobile device, e.g., so that an attempt to perform an ecommerce transaction using a different mobile device will fail.

According to another aspect, the subject matter described herein includes a method for generating and completing an ecommerce transaction at a physical store. The method includes, at a mobile backend server for storing and maintaining payment information for mobile users: receiving, from a mobile device of a user, information identifying a physical store transaction terminal; requesting and receiving, from the identified physical store transaction terminal, information about a transaction desired by the user, the information including an amount of the transaction; and forwarding the information about the transaction to the user's mobile device for approval by the user. The method also includes receiving, from the user's mobile device, approval from the user to perform the desired transaction, and, in response to receiving the approval, determining payment information associated with the user, and forwarding at least some of the payment information and at least some of the transaction information to a payment network for initiating the desired transaction. The ecommerce transaction may be a CNP transaction.

According to yet another aspect, the subject matter described herein includes a method for merchants to provide users with an incentive to use a merchant-preferred payment type for ecommerce transactions. The method includes, at a mobile backend server for storing and maintaining payment information for mobile users, storing information that associates a mobile user with payment information for that user, the payment information including a payment type, and storing information that associates a merchant with a list of payment types supported by that merchant and information that identifies a merchant preference for payment types. The method also includes receiving a request for payment information, the request including information identifying a mobile user and information identifying a merchant, and, in response to receiving the request, using the information identifying a mobile user and the information identifying the merchant to determine payment types supported by both the mobile user and the merchant and providing to the user an incentive to use a payment type that is preferred by the merchant.

According to yet another aspect, the subject matter described herein includes a system for authenticating a mobile device for ecommerce transactions. The system includes a database for storing and maintaining payment information for mobile users. The system also includes a mobile backend server that receives, from a mobile user, information associated with a payment card, the information including a billing address and a card security code; that performs an authentication only reversible transaction for a nominal amount using an ecommerce format; and that, upon receiving approval for the transaction, stores the information except for the card security code into the database, associates the mobile user to the stored information, and authenticates the combination of the mobile user and the stored information for ecommerce transactions.

According to yet another aspect, the subject matter described herein includes a system for generating and completing an ecommerce transaction at a physical store. The system includes a database for storing and maintaining payment information for mobile users. The system also includes a mobile backend server that receives, from a mobile device of a user, information identifying a physical store transaction terminal; that requests and receives from the identified physical store transaction terminal, information about a transaction desired by the user, the information including an amount of the transaction; that forwards the information about the transaction to the user's mobile device for approval by the user; that receives, from the user's mobile device, approval from the user to perform the desired transaction; and that, in response to receiving the approval, retrieves from the database payment information associated with the user and forwards at least some of the payment information to a payment network for initiating the desired transaction.

According to yet another aspect, the subject matter described herein includes A system for merchants to provide users with an incentive to use a merchant-preferred payment type for ecommerce transactions. The system includes a database for storing and maintaining payment information for mobile users, and a mobile backend server for storing, in the database, information that associates a mobile user with payment information for that user, the payment information including a payment type, information that associates a merchant with a list of payment types supported by that merchant, and information that identifies a merchant preference for payment types. The mobile backend server receives a request for payment information, the request including information identifying a mobile user and information identifying a merchant, and, in response to receiving the request, uses the information identifying a mobile user and the information identifying the merchant to determine payment types supported by both the mobile user and the merchant and provides to the user an incentive to use a payment type that is preferred by the merchant.

The subject matter described herein may be implemented in hardware, software, firmware, or any combination thereof. As such, the terms “function” or “module” as used herein refer to hardware, software, and/or firmware for implementing the feature being described.

In one exemplary implementation, the subject matter described herein may be implemented using a computer readable medium having stored thereon executable instructions that when executed by the processor of a computer control the computer to perform steps. Exemplary computer readable media suitable for implementing the subject matter described herein include disk memory devices, chip memory devices, programmable logic devices, application specific integrated circuits, and other non-transitory storage media. In one implementation, the computer readable medium may include a memory accessible by a processor of a computer or other like device. The memory may include instructions executable by the processor for implementing any of the methods described herein. In addition, a computer readable medium that implements the subject matter described herein may be located on a single device or computing platform or may be distributed across multiple physical devices and/or computing platforms.

### BRIEF DESCRIPTION OF THE DRAWINGS

Embodiments of the subject matter described herein will now be explained with reference to the accompanying drawings, wherein the like reference numerals represent like parts, of which:

FIG. 1 is a block diagram illustrating an exemplary system for authenticating a mobile device for ecommerce transactions according to an embodiment of the subject matter described herein. The system components illustrated in FIG. 1 may also be used for generating a completing an ecommerce transaction at a physical store and for merchants to provide users with an incentive to use a merchant-preferred payment type for ecommerce transactions, according to other embodiments of the subject matter described herein.

FIG. 2 is signal messaging diagram illustrating messages communicated among components of an exemplary system for authenticating a mobile device for ecommerce transactions according to an embodiment of the subject matter described herein;

FIGS. 3A and 3B are signal messaging diagrams illustrating messages communicated among components of an exemplary system for generating and completing an ecommerce transaction at a physical store according to an embodiment of the subject matter described herein; and

FIGS. 4A and 4B are signal messaging diagrams illustrating messages communicated among components of an exemplary system for merchants to provide users with an incentive to use a merchant-preferred payment type for ecommerce transactions according to an embodiment of the subject matter described herein.

### DETAILED DESCRIPTION

Methods and systems for performing a physical point of sale (POS) transaction as an ecommerce transaction initiated through a mobile are provided herein. The subject matter described herein includes a system and methods for authenticating a mobile user for ecommerce transactions, for generating and completing an ecommerce transaction at a physical store, and for enabling merchants to provide users with an incentive to use a merchant-preferred payment type for ecommerce transactions.

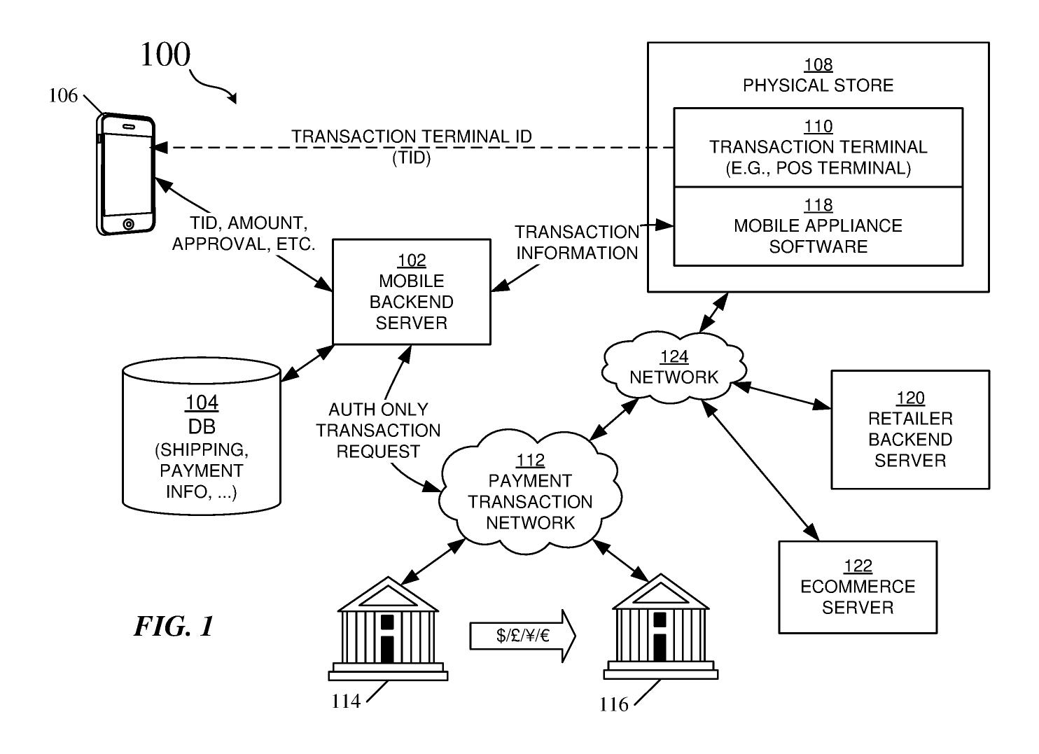

FIG. 1 is a block diagram illustrating an exemplary system for authenticating a mobile device for ecommerce transactions according to an embodiment of the subject matter described herein. In the embodiment illustrated in FIG. 1, system 100 includes a mobile backend server 102 that communicates with a database 104 database for storing and maintaining payment information for mobile users.

Mobile backend server 102 receives, from a mobile device 106 of a user, information identifying a physical store 108 transaction terminal 110. In the embodiment illustrated in FIG. 1, this information is referred to as a terminal identifier, or TID. In response to receiving this information, mobile backend server 102 sends a request to and receives from the identified physical store transaction terminal 110 information about a transaction desired by the user (the “transaction information”), the information including an amount of the transaction. Mobile backend server 102 that forwards the information about the transaction to mobile device 106 for presentation to and, approval by, the user.

If the user approves the transaction, mobile backend server 102 will receive notification of this approval from mobile device 102, and in response to receiving this approval, mobile backend server 102 may query database 104 to get payment information associated with the user. Mobile backend server may then forward at least some of the payment information to a payment network 112 for initiating the desired transaction.

In the example scenarios illustrated in FIG. 1, the desired transaction is a payment or other money transfer from one financial institution to another, such as a debit payment from an issuing bank 114 to an acquiring bank 116, e.g., from the card holder's account to the merchant's account for the payment of goods purchased.

In the embodiment illustrated in FIG. 1, system 100 may include mobile appliance software 118 for interacting with mobile backend server 102. Mobile appliance software 118 may be installed within transaction terminal 110, outside of transaction terminal 110 but within physical store 108, or even outside of physical store 108.

In the embodiment illustrated in FIG. 1, system 100 may include a retailer backend server 120, which handles retailer backend functions including, but not limited to, maintaining product and price data bases for use by the transaction terminals 110, maintaining membership and loyalty card accounts, and providing additional information as needed to the physical store 108, the payment transaction network 112, or other entities within system 100.

In the embodiment illustrated in FIG. 1, system 100 may include an ecommerce server 122 that manages ecommerce transactions on behalf of the merchant. Although the corporate entity that owns or controls the physical store 108 is usually the same as the corporate entity that owns or controls the ecommerce server 122, that is not always the case. For example, a small business may contract with an ecommerce service provider to handle web-site based commerce, in which case the physical store 108 may be owned by one corporate entity while the ecommerce server 122 may be owned by another corporate entity.

In the embodiment illustrated in FIG. 1, the various entities within system 100 may communicate with each other via a data or telecommunications network 124, but other communications configurations (e.g., private dedicated line, public network, the Internet, communication via virtual private network or VPN, etc.) are also within the scope of the subject matter described herein.

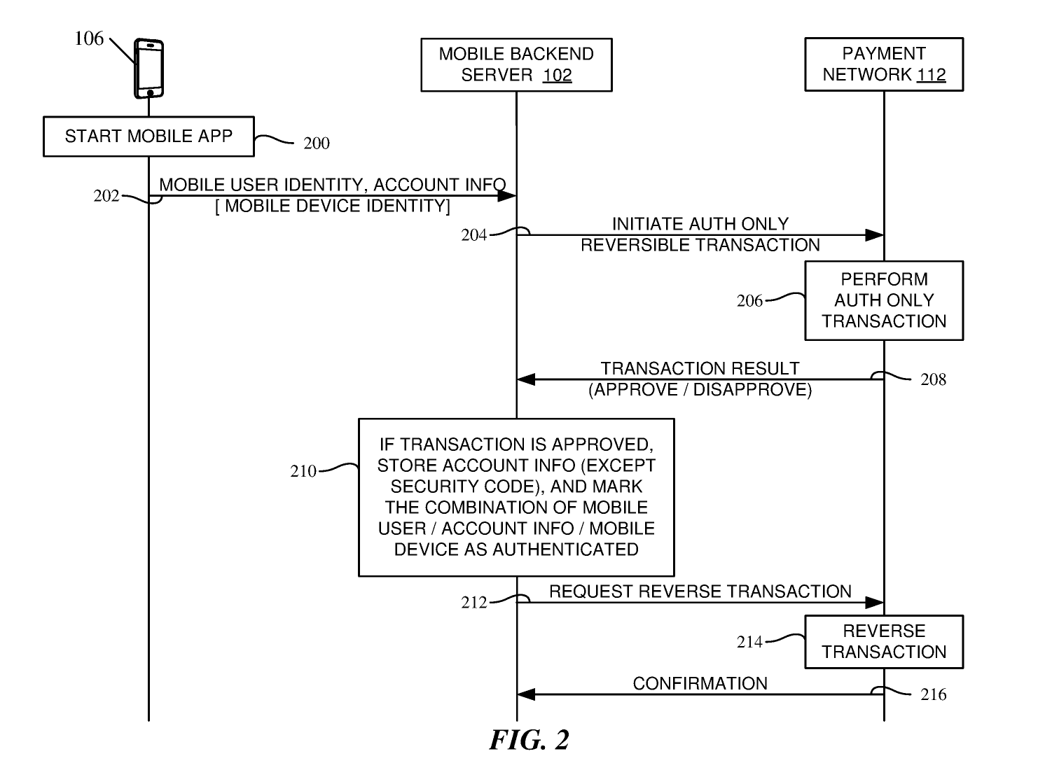

An example operation of system 100 for authenticating a mobile device for ecommerce transactions will now be described using FIG. 2.

FIG. 2 is signal messaging diagram illustrating messages communicated among components of an exemplary system for authenticating a mobile device for ecommerce transactions according to an embodiment of the subject matter described herein. FIG. 2 illustrates interactions between a mobile device 106, mobile backend server 102 for storing and maintaining payment information for mobile users, and a payment network 112, such as the like-numbered elements in FIG. 1.

In the embodiment illustrated in FIG. 2, a user of mobile device 106 starts a mobile application (block 200) and uses the mobile application to transmit information to mobile backend server 102 (message 202). That information may include information identifying the mobile user, information associated with a payment card or other financial instrument, including a billing address and a card security code, and may optionally include information identifying mobile device 106.

In response to receiving this information, mobile backend server 102 authenticates the mobile device by initiating an “authorization only” reversible transaction (hereinafter referred to as an “auth only transaction”) for a nominal amount (such as one U.S. dollar) using an ecommerce format. In the embodiment illustrated in FIG. 2, for example, mobile backend server 102 communicates a request (message 204) to payment network 112. Payment network 112 attempts to perform the transaction (block 206) and returns the auth only transaction result to mobile backend server 102 (message 208).

At block 210, if the transaction was approved, mobile backend user 102 stores the information contained within message 202, except for the card security code, and marks some combination of mobile user, account information, and/or mobile device as being authenticated. In one embodiment, mobile backend server 102 may then reverse the transaction for the nominal amount if needed so that the user's account balance doesn't change as a result of the authentication process. In the embodiment illustrated in FIG. 2, the mobile backend server 102 issues a request to reverse the transaction (message 212), which the payment network 112 receives and then performs (block 214). In one embodiment, the payment network 112 sends confirmation (message 216) to the mobile backend server 102.

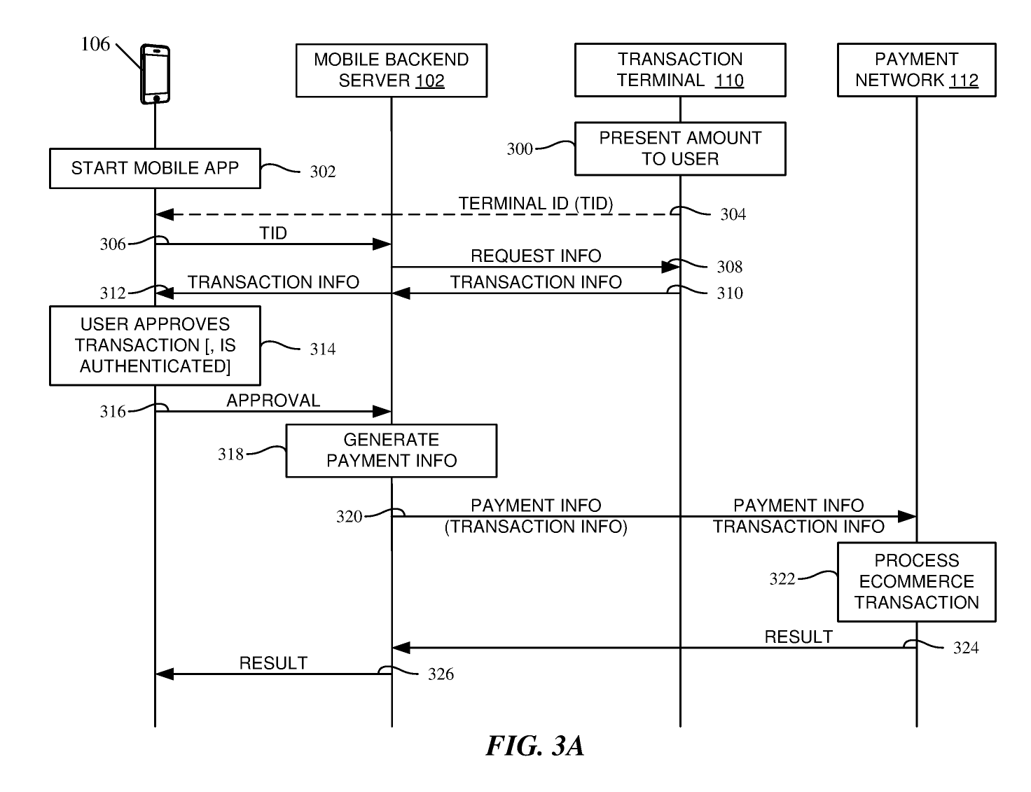

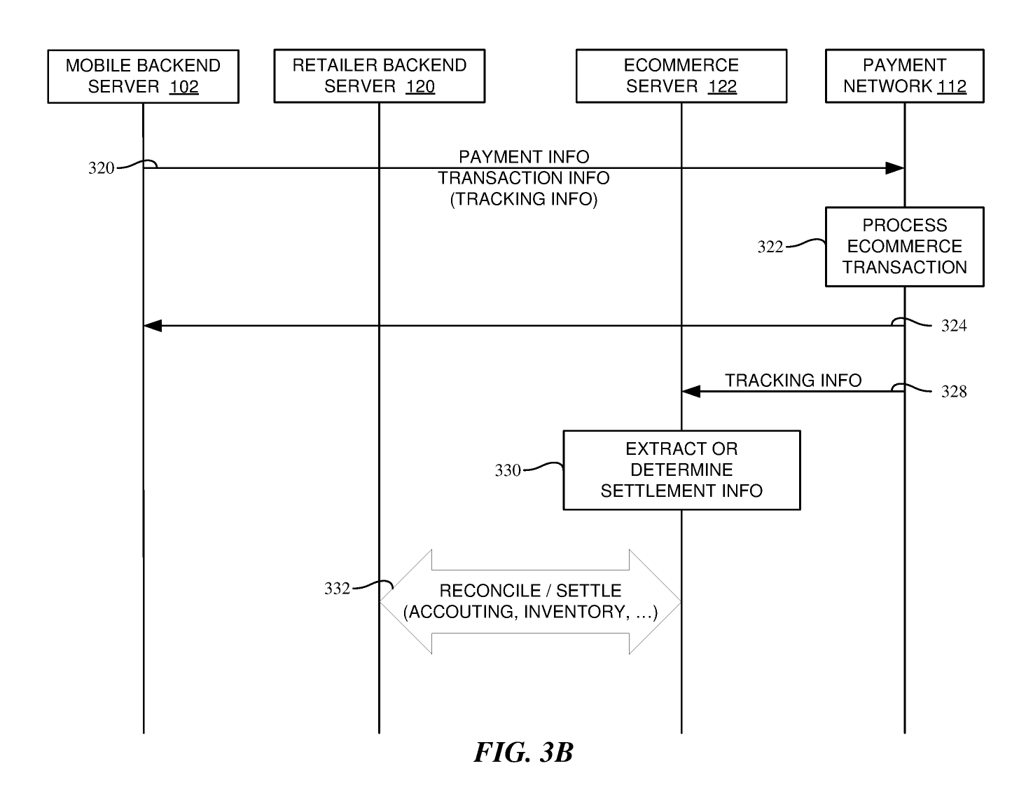

The system components illustrated in FIG. 1 may also be used for generating a completing an ecommerce transaction at a physical store according to another embodiment of the subject matter described herein. An example operation of system 100 for generating a completing an ecommerce transaction at a physical store will now be described using FIGS. 3A and 3B.

FIGS. 3A and 3B are signal messaging diagrams illustrating messages communicated among components of an exemplary system for generating and completing an ecommerce transaction, such as a CNP transaction, at a physical store according to an embodiment of the subject matter described herein.

In the embodiment illustrated in FIG. 3A, a user of mobile device 106 desires to perform an ecommerce transaction at physical store transaction terminal 110, e.g., at a POS terminal. Transaction terminal 110 typically displays or presents to the user information about the desired transaction, such as the amount of the transaction (block 300). To perform the transaction via the user's mobile phone 106, the user may start a mobile application for that purpose (block 302).

In the embodiment illustrated in FIG. 3A, the mobile application determines the identity of transaction terminal 110. This may be achieved, for example, by receiving a terminal identifier (TID) from transaction terminal 110 (message 304). In one embodiment, mobile device 106 may scan a bar code or QR code that encodes at least the TID; the mobile application may then decode the scanned bar code or QR code to extract the TID. In another embodiment, mobile device 106 may receive the TID via wired or wireless communication from transaction terminal 110, from some other entity within physical store 108, or even from some entity other than physical store 108, such as from a merchant website. In yet another embodiment, mobile device 106 may receive the TID as a media file that includes the TID encoded within; the mobile application may then decode the media file to extract the TID. In yet another embodiment, the user may enter the TID manually via the mobile application. Other means and mechanisms to convey the TID to the mobile application are also contemplated by the subject matter within. Once the mobile application determines the TID, mobile device 106 forwards that information to mobile backend server 102 (message 306).

Mobile backend server 102 then uses the TID to identify transaction terminal 110 so that it can request (message 308) and receive (message 310) information about the transaction, or “transaction info”, which is forwarded to mobile device 106 (message 312) and displayed to the user for approval.

If the user approves the transaction (block 314), mobile device 106 will send notification of the approval (message 316) to mobile backend server 102. In response to receiving approval, mobile backend server 102 generates payment information (block 318). In one embodiment, mobile backend server 102 may query database 104 to retrieve the payment information associated with the user of mobile device 106. As will be described in more detail below, mobile backend server 102 may have previously authenticated the combination of mobile user and payment information (or some combination of mobile user, mobile device, and payment information, for example.) Mobile backend server 102 then forwards at least some of that payment information to payment network 112 (message 320).

In one embodiment, mobile backend server 102 may forward the payment information to transaction terminal 110, which forwards the payment information with at least some of the transaction information to payment network 112. In an alternative embodiment, mobile backend server 102 may forward both payment information and transaction information directly to payment network 112, bypassing transaction terminal entirely.

Once the payment and transaction information is received by payment network 112, it may process, or initiate process of, an ecommerce transaction, such as a CNP transaction (block 322). In one embodiment, payment network 112 may forward the result of the transaction to mobile backend server 102 (message 324), which may forward the result on to the user's mobile device (message 326).

Because the user has purchased items from a physical store but paid for them via an ecommerce transaction, it may be necessary to provide a mechanism by which the physical store and the ecommerce entity can reconcile or settle with each other both in financial/accounting terms but also in terms of inventory, since the physical store released the goods to the buyer but the ecommerce site received the payment for those goods. An example of this process is shown in FIG. 3B.

In the embodiment illustrated in FIG. 3B, the steps of sending payment information 320, processing the ecommerce transaction 322, and reporting the results 324 are essentially identical to like-numbered elements in FIG. 3A, with the exception that, in FIG. 3B, the mobile backend server 102 generates and sends tracking information along with the payment information 320 to the payment network 112. In the embodiment illustrated in FIG. 3B, if the ecommerce transaction is processed successfully in block 322, the payment network sends the tracking information to the ecommerce server 122 (message 328). The ecommerce server 122 uses the tracking information to determine the settlement information (block 330), after which the ecommerce server 122 and retailer backend server 120 (and/or the physical store 108 or one of its entities) engage in a reconciliation or settlement (interaction 332).

Examples of settlement information include, but are not limited to: the authorization code from the payment network; information about the objects of the transaction, such as the product type, description, quantity, unit price, and so on; information about the transaction itself, such as the date, time, and location; payment information, such as the total amount, tax, card number, payment instrument, and payment transaction token; and user information, such as the user's name, address, loyalty number, membership number, and the like. In one embodiment, the tracking information contains some or all of the settlement information. In another embodiment, the tracking information is or contains a pointer or reference which may be used to retrieve some or all of the settlement information, e.g., from a database or data store.

In one embodiment, the reconciliation or settlement process can occur shortly after the transaction occurs. In one embodiment, this process can occur periodically, such as at the end of the day, at the close of business, or other time. Settlement may involve the physical store 102 getting credit for the sale of the goods, and may involve processing of coupons, manufacturer's rebates, and the like. Settlement may trigger the supply chain of the physical store to update that store's inventory.

In an alternative embodiment, the tracking information may be generated by some entity other than the mobile backend server 102, such as by the payment network 112 or the ecommerce server 122 and communicated to the parties to the process as needed.

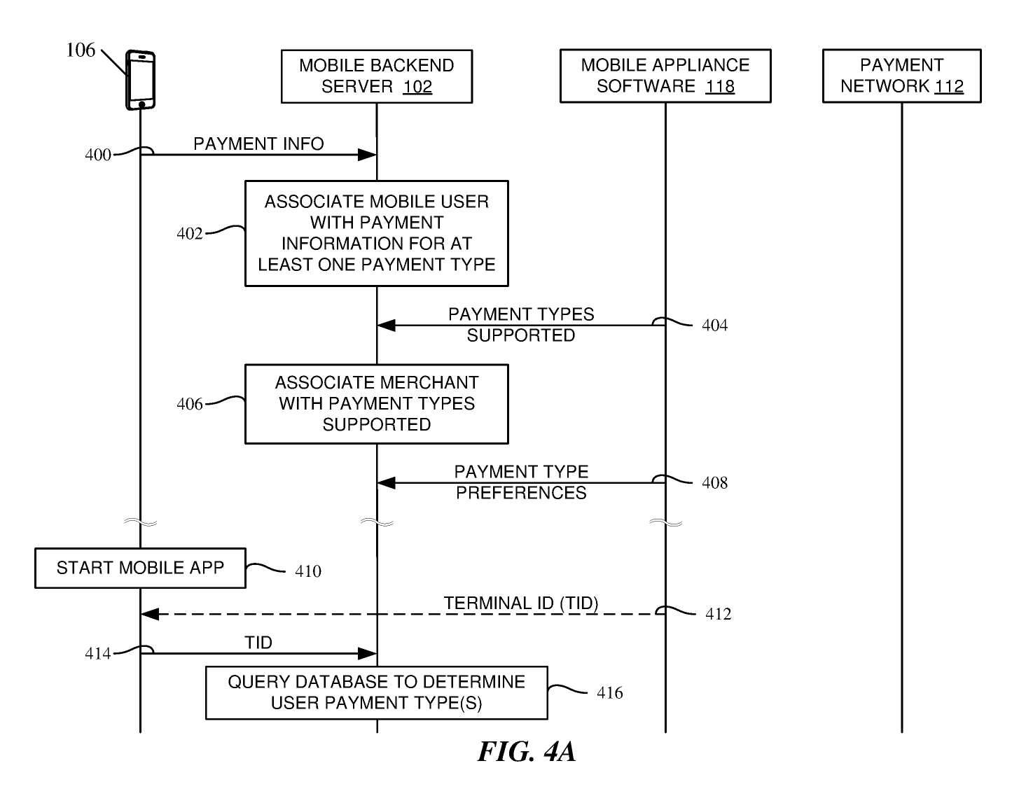

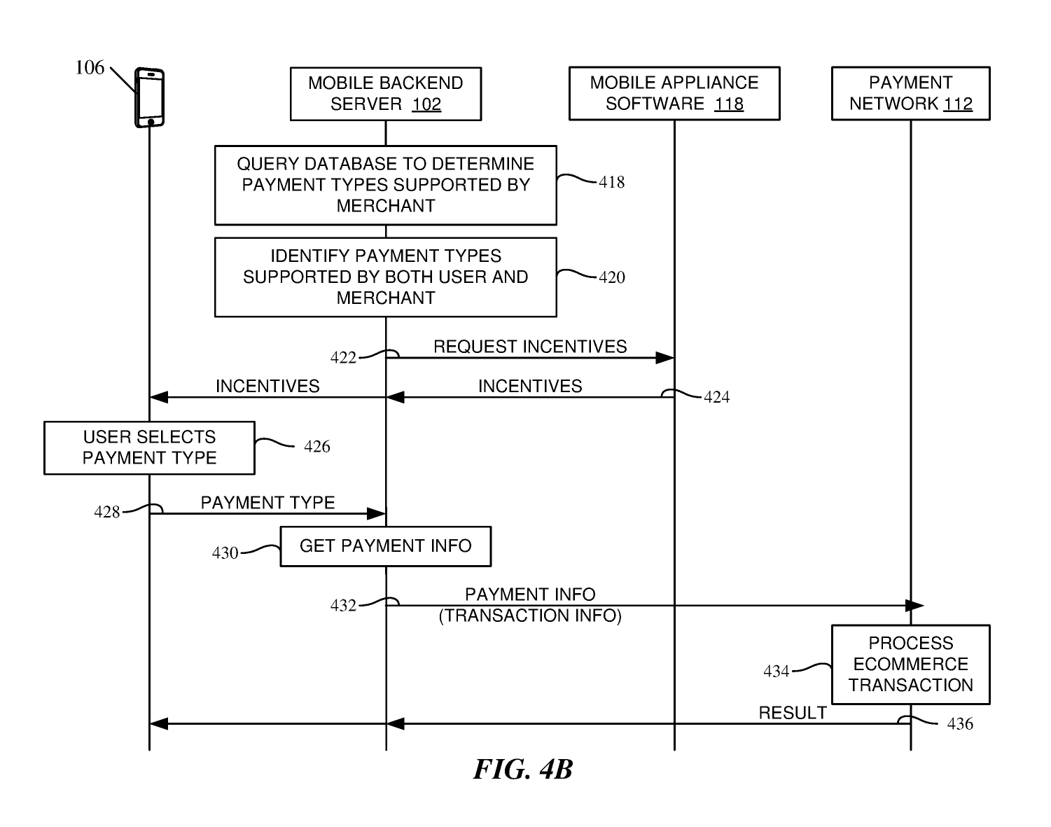

FIGS. 4A and 4B are signal messaging diagrams illustrating messages communicated among components of an exemplary system for merchants to provide users with an incentive to use a merchant-preferred payment type for ecommerce transactions according to an embodiment of the subject matter described herein.

Referring now to FIG. 4A, prior to performing a payment transaction, a user will enter or register his or her payment information, such as card data, payment account information, or other data, for use by a system according to an embodiment of the subject matter described herein, such as system 100. In the embodiment illustrated in FIG. 4A, a user's payment information is received by mobile backend server 102. In the embodiment illustrated in FIG. 4A, this payment information is received from a mobile device 106 owned or used by the mobile user (message 400), but mobile backend server 102 may receive this information from other entities, such as from a personal computer hosting a web browser that is using a web portal provided by mobile backend server 102 for that purpose, via text message, email, or other means. At block 402, the mobile user is associated with payment information for each of one or more payment types. This association may be stored in a database, such as database 104 in FIG. 1.

Mobile backend server 102 may also receive and store information for each merchant, such as which payment types that merchant supports. In the embodiment illustrated in FIG. 4A, this information may be provided by mobile appliance software 118 (message 404), but this information may be provided by other sources. At block 406, payment types supported by a merchant are associated with that merchant. This association may be stored in a database, such as database 104.

A merchant may have a preferred payment type. In the embodiment illustrated in FIG. 4, this information about merchant payment type preferences may be provided to mobile backend server 102 from mobile appliance software 118 (message 408), but this information too may come from other sources.

Sometime after the information has been stored by mobile backend server 102, the user may desire to initiate an electronic transaction. In the embodiment illustrated in FIG. 4A, the user of mobile device 106 wants to perform an ecommerce transaction using mobile device 106, and therefore starts a mobile application (block 410), receives a POS terminal ID (TID) from the terminal or some other entity (message 412), which it forward to mobile backend server 102 (message 414). In one embodiment, mobile backend server 102 uses the TID to identify which mobile appliance software 118 should be the recipient of a request for incentive information. The process continues in FIG. 4B.

In the embodiment illustrated in FIG. 4B, at block 416, mobile backend server 102 determines what payment types are supported by the user, e.g., by querying database 104 for that information. In the embodiment illustrated in FIG. 4B, at block 418, mobile backend server 102 determines what payment types are supported by the merchant, e.g., by also querying database 104 for that information.

In one embodiment, once mobile backend server 102 determines whether any of the payment types supported by the user are also supported by the merchant (block 420), it may present to the user a list of the available payment types in a manner that highlights the merchant-preferred payment types. In the embodiment illustrated in FIG. 4B, the merchant's preferences are reflected in incentives provided to the user. In one embodiment, mobile backend server may send a request (message 422) to the merchant for a list of incentives for one or more of the payment types that are supported by both the user and the merchant. The merchant may reply with incentives for one or more of the commonly-supported payment types (message 424), which mobile backend server may forward to mobile device 106 for display to the user.

At block 426, the user selects the payment type that he or she wants to use, and that information is conveyed to mobile backend server 102 (message 428). Mobile backend server 102 then gets payment information for that payment type (block 430). In the embodiment illustrated in FIG. 4B, mobile backend server 102 then uses that information (along with transaction information, if present) to a payment network 112 (message 432), and as a result, an ecommerce transaction is processed (block 434). In one embodiment, the result of the transaction is forwarded to the user, e.g., to mobile device 106 via mobile backend server 102 (message 436).

Examples of incentives include, but are not limited to, discounts, markdowns, specials, coupons, special offers, and the like. Merchants can use the incentives to try to steer the customer towards payment types that the merchant prefers, e.g., payment types that have less overhead costs to the merchant. For example, a merchant can provide incentives that vary according to payment type, such as offering a 10% discount if the customer pays via ACH and a 15% discount if the customer uses a signature debit card.

In one embodiment, the user may be a member of a rewards or loyalty program, and/or may be a member of a class or tier, such gold club member, silver club member, etc. This information may also be stored in database 104 and used by mobile backend server 102. For example, when mobile backend server 102 queries database 104 to determine payment types supported by the user, it may also retrieve gold/silver/bronze status and the like, which it can then use to determine available incentives, such as via request 422 in FIG. 4B. In this manner, the incentive provided to the user may vary according to the user's class or tier. In one embodiment, mobile backend server 102 may only store general categories (such as gold, silver, bronze, etc.), leaving to the merchant the task of determining what each category actually means in terms of incentives. Alternatively, mobile backend server may store the particular incentives for each user based on that user's class or category, in which case message 422 and the first part of message 424 would not be necessary in FIG. 4B. Thus, the incentive provided to the user may vary according to the total value of the transaction, vary according to a user's profile and/or loyalty status, and so on.

In one embodiment, the particular provided to the user may vary for each item, product, or product type. In this embodiment, incentive request 422 may include a list of one or more specific items, products, or product types. The merchant could use this information to give specific incentives on a product-by-product basis, rather than a overall discount or incentive to club members. In one embodiment, the incentive(s) available to a user based on payment type may also vary from merchant to merchant.

In one embodiment, the incentive can take the form of a coupon, which is provided to the user electronically, via the user's mobile device, or some other means, which the user redeems at time of purchase to receive the discount.

In the embodiment illustrated in FIGS. 4A and 4B, the steps of determining payment types supported by the user (block 416) determining payment types supported by a merchant (block 418) and reconciling the two (block 420) occur just before the time of a transaction, but in alternative embodiments, these steps could occur at other times. For example, in one embodiment, the actions taken in blocks 416, 418, and 420 in FIG. 4B could instead occur during registration, e.g., after block 406 in FIG. 4A, during both registration and transaction, or at other times, such as when a user's status or profile changes (e.g., adding or deleting a new card, adding or deleting a merchant, changing a membership tier or status, etc.)

In some of the embodiments described above, the user's mobile device 106 is being used to perform an ecommerce transaction while the user is standing at a POS terminal, but the same principles may be applied where a user is using a kiosk or unattended sales terminal to perform a transaction. That is, the term “transaction terminal” is not limited to traditional POS terminals or cash registers. Examples of other types of transaction terminals include, but are not limited to, kiosks, unattended sales terminals, and product displays which feature a QR code, bar code, or text that can be manually entered, any of which identify a merchant (and optionally also identify a product or service). In one embodiment, a product display at a store may include a QR code that the user can scan with mobile device 106 and send to mobile backend server 102, which engages in the processes described above. The QR code may identify the merchant, a store location, and a product or service which is then purchased using an ecommerce transaction as described above—without being anywhere near a POS terminal or cash register.

### Embodiments

1. A method for authenticating a mobile user for ecommerce transactions, the method comprising, at a mobile backend server for storing and maintaining payment information for mobile users: receiving, from a mobile user, information associated with a payment card, the information including a billing address and a card security code; performing an authentication only reversible transaction for a nominal amount using an ecommerce format; and, upon receiving approval for the transaction, storing the information except for the card security code, associating the mobile user to the stored information, and authenticating the combination of the mobile user and the stored information for ecommerce transactions.

2. The method of embodiment 1 comprising, upon receiving approval for the transaction, reversing the transaction.

3. The method of embodiment 2 wherein reversing the transaction includes performing a credit transaction for the nominal amount.

4. The method of embodiment 1 wherein the information associated with the payment card includes at least one of: a primary account number, a card type, a payment type, information identifying a user of the card, an expiration date, and information identifying a financial institution.

5. The method of embodiment 1 wherein the card security code comprises a card verification value (CVV) code.

6. The method of embodiment 1 wherein the nominal amount comprises one United States dollar.

7. The method of embodiment 1 wherein associating the mobile user to the stored information includes storing that association in a database accessible by the mobile backend server.

8. The method of embodiment 1 wherein authenticating the combination of the mobile user and the stored information includes identifying the combination as having been authenticated.

9. The method of embodiment 1 comprising receiving information identifying a mobile device used by the mobile user and wherein authenticating the combination of the mobile user and the stored information for ecommerce transactions includes authenticating the combination of the mobile user, the mobile device, and the stored information.

10. The method of embodiment 9 wherein authenticating the combination of the mobile user, the mobile device, and the stored information includes identifying the combination as having been authenticated.

11. The method of embodiment 1 wherein the mobile user is authenticated for ecommerce transactions involving a specific merchant, for ecommerce transactions using a specific payment type, or a combination of the above.

12. A method for generating and completing an ecommerce transaction at a physical store, the method comprising, at a mobile backend server for storing and maintaining payment information for mobile users: receiving, from a mobile device of a user, information identifying a physical store transaction terminal; requesting and receiving, from the identified physical store transaction terminal, information about a transaction desired by the user, the information including an amount of the transaction; forwarding the information about the transaction to the user's mobile device for approval by the user; receiving, from the user's mobile device, approval from the user to perform the desired transaction; and in response to receiving the approval: determining payment information associated with the user; and forwarding at least some of the payment information and at least some of the transaction information to a payment network for initiating the desired transaction.

13. The method of embodiment 12 wherein forwarding at least some of the payment information and at least some of the transaction information to a payment network includes forwarding at least some of the payment information to the physical store transaction terminal and wherein the physical store transaction terminal forwards the received payment information along with at least some of the information about the transaction to the payment network.

14. The method of embodiment 12 wherein forwarding at least some of the payment information and at least some of the transaction information to a payment network includes sending the payment and transaction information to the payment network directly and not sending that information to the physical store transaction terminal.

15. The method of embodiment 12 comprising initiating the transaction at the payment network.

16. The method of embodiment 15 comprising receiving, at the mobile backend server and from the payment network, a result of the initiated transaction.

17. The method of embodiment 16 wherein receiving the result of the initiated transaction from the payment network includes at least one of: receiving the result via the physical store transaction terminal; and receiving the result directly from the payment network without going through the physical store transaction terminal.

18. The method of embodiment 12 wherein the payment information includes information that identifies a financial institution.

19. The method of embodiment 12 wherein the payment information includes a name of the user or information identifying the user's membership in a loyalty, rewards, or discount program.

20. The method of embodiment 12 wherein the requested ecommerce transaction comprises at least one of: a payment or purchase; a credit transaction; a debit transaction; a deposit; a withdrawal; a money transfer; a transaction involving a loyalty program; a transaction involving a rewards program; and a transaction involving a diet, health, or fitness program.

21. The method of embodiment 12 wherein, prior to receiving the information identifying a physical store transaction terminal from the mobile device, the mobile device receives the information identifying the physical store transaction terminal (TID).

22. The method of embodiment 21 wherein the TID includes at least one of: a uniform resource identifier of the physical store transaction terminal; a network address of the physical store transaction terminal; a uniform resource identifier of a server that serves the physical store transaction terminal; and a network address of a server that serves the physical store transaction terminal.

23. The method of embodiment 21 wherein the mobile device receives the TID from the physical store transaction terminal or from a physical store entity other than the transaction terminal.

24. The method of embodiment 23 wherein the mobile device receives the TID by scanning a bar code or QR code that encodes the TID.

5. The method of embodiment 24 wherein the bar code or QR code is presented to the mobile device by at least one of the physical store transaction terminal and the physical store entity other than the transaction terminal and wherein the mobile device decodes the bar code or QR code to extract the TID.

26. The method of embodiment 23 wherein the mobile device receives the TID by receiving the TID electronically via a wired or wireless communication protocol.

27. The method of embodiment 26 wherein receiving the TID electronically via a wireless communication protocol includes receiving the TID using near field communication (NFC), Bluetooth, Wi-Fi, Wi-Fi Direct, or cellular communication.

28. The method of embodiment 23 wherein the mobile device receives the TID by detecting or recording a media file that encodes the TID into a media format and wherein the mobile device decodes the media file to extract the TID.

29. The method of embodiment 12 comprising, prior to sending approval from the user to perform the desired transaction, authenticating the user by the mobile device.

30. The method of embodiment 29 wherein authenticating the user by the mobile device includes receiving, at the mobile device, identification information for identifying the user and authentication information for authenticating the identity of the user and using the authentication information to authenticate the identity of the user.

31. The method of embodiment 30 wherein the information for identifying or authenticating the identity of the user includes at least one of: a name of the user; an address of the user; an identification number associated with the user; biometric information provided by the user; a password, passcode, or personal information number (PIN) of the user; a digital signature of the user, a geo-location of the user, or information from the user's social network.

32. The method of embodiment 30 wherein authentication of the identity of the user is performed by the mobile device.

33. The method of embodiment 30 comprising, at the backend mobile server, receiving from the mobile device identification information and authentication information and using the received information to authenticate the user.

34. The method of embodiment 30 wherein the identification or authentication information is provided by the user or by entity different from the user.

35. A method for merchants to provide users with an incentive to use a merchant-preferred payment type for ecommerce transactions, the method comprising, at a mobile backend server for storing and maintaining payment information for mobile users: storing information that associates a mobile user with payment information for that user, the payment information including a payment type; storing information that associates a merchant with a list of payment types supported by that merchant and information that identifies a merchant preference for payment types; receiving a request for payment information, the request including information identifying a mobile user and information identifying a merchant; and in response to receiving the request, using the information identifying a mobile user and the information identifying the merchant to determine payment types supported by both the mobile user and the merchant and providing to the user an incentive to use a payment type that is preferred by the merchant.

36. The method of embodiment 35 comprising receiving, from the mobile user, a payment type selection; determining payment information associated with the selected payment type; and initiating an ecommerce transaction using the determined payment information.

37. The method of embodiment 35 wherein the incentive provided to the user varies according to payment type.

38. The method of embodiment 37 wherein the incentive provided to the user is larger for more-preferred payment types and smaller for less-preferred payment type.

39. The method of embodiment 35, comprising storing information that indicates the mobile user's class or tier for a particular merchant.

40. The method of embodiment 39 wherein the incentive provided to the user varies according to the user's class or tier.

41. The method of embodiment 35 wherein providing an incentive to use a merchant-preferred payment type includes providing a discount to the user for using a merchant-preferred payment type.

42. The method of embodiment 41 wherein providing a discount to the user includes providing to the user a coupon, which the user redeems to receive the discount.

43. The method of embodiment 42 wherein at least one of providing the coupon and redeeming the coupon is performed electronically using a mobile device of the user.

44. The method of embodiment 35 wherein the incentive provided to the user varies according to a specific item, product, or product type purchased.

45. The method of embodiment 35 wherein the incentive provided to the user varies according to a total value of the transaction.

46. The method of embodiment 35 wherein the incentive provided to the user varies according to the user's profile and/or the user's loyalty status.

47. The method of embodiment 35 wherein the incentive provided to the user varies according to the merchant.

48. The method of embodiment 35 wherein providing the incentive to the user includes delivering or displaying the incentive to the user via a mobile device of the user.

49. A system for authenticating a mobile device for ecommerce transactions, the system comprising: a database for storing and maintaining payment information for mobile users; and a mobile backend server that receives, from a mobile user, information associated with a payment card, the information including a billing address and a card security code; that performs an authentication only reversible transaction for a nominal amount using an ecommerce format; and that, upon receiving approval for the transaction, stores the information except for the card security code into the database, associates the mobile user to the stored information, and authenticates the combination of the mobile user and the stored information for ecommerce transactions.

50. The system of embodiment 49 wherein, upon receiving approval for the transaction, the mobile backend server reverses the transaction.

51. The system of embodiment 50 wherein reversing the transaction includes performing a credit transaction for the nominal amount.

52. The system of embodiment 49 wherein the information associated with the payment card includes at least one of: a primary account number, a card type, a payment type, information identifying a user of the card, an expiration date, and information identifying a financial institution.

53. The system of embodiment 49 wherein the card security code comprises a card verification value (CVV) code.

54. The system of embodiment 49 wherein the nominal amount comprises one United States dollar.

55. The system of embodiment 49 wherein associating the mobile user to the stored information includes storing that association in a database accessible by the mobile backend server.

56. The system of embodiment 49 wherein authenticating the combination of the mobile user and the stored information includes identifying the combination as having been authenticated.

57. The system of embodiment 49 wherein the mobile backend server receives information identifying a mobile device used by the mobile user and wherein authenticating the combination of the mobile user and the stored information for ecommerce transactions includes authenticating the combination of the mobile user, the mobile device, and the stored information.

58. The system of embodiment 57 wherein authenticating the combination of the mobile user, the mobile device, and the stored information includes identifying the combination as having been authenticated.

59. The system of embodiment 49 wherein the mobile user is authenticated for ecommerce transactions involving a specific merchant, for ecommerce transactions using a specific payment type, or a combination of the above.

60. A system for generating and completing an ecommerce transaction at a physical store, the system comprising: a database for storing and maintaining payment information for mobile users; and a mobile backend server that receives, from a mobile device of a user, information identifying a physical store transaction terminal; that requests and receives from the identified physical store transaction terminal, information about a transaction desired by the user, the information including an amount of the transaction; that forwards the information about the transaction to the user's mobile device for approval by the user; that receives, from the user's mobile device, approval from the user to perform the desired transaction; and that, in response to receiving the approval, retrieves from the database payment information associated with the user and forwards at least some of the payment information to a payment network for initiating the desired transaction.

61. The system of embodiment 60 wherein the mobile backend server forwards the at least some of the payment information to the physical store transaction terminal and wherein the physical store transaction terminal forwards the received payment information along with at least some of the information about the transaction to the payment network.

62. The system of embodiment 60 wherein the mobile backend server forwards the at least some of the payment information along with at least some of the transaction information to a payment network directly without sending that information to the physical store transaction terminal.

63. The system of embodiment 60 the payment network initiates the transaction.

64. The system of embodiment 63 wherein the payment network sends a result of the initiated transaction to the mobile backend server.

65. The system of embodiment 64 wherein the payment network sends the result to the mobile backend server via the physical store transaction terminal or sends the result to the mobile server directly without going through the physical store transaction terminal.

66. The system of embodiment 60 wherein the payment information includes information that identifies a financial institution.

67. The system of embodiment 60 wherein the payment information includes a name of the user or information identifying the user's membership in a loyalty, rewards, or discount program.

68. The system of embodiment 60 wherein the requested ecommerce transaction comprises at least one of: a payment or purchase; a credit transaction; a debit transaction; a deposit; a withdrawal; a money transfer; a transaction involving a loyalty program; a transaction involving a rewards program; and a transaction involving a diet, health, or fitness program.

69. The system of embodiment 60 wherein, prior to receiving the information identifying a physical store transaction terminal from the mobile device, the mobile device receives the information identifying the physical store transaction terminal (TID).

70. The system of embodiment 69 wherein the TID includes at least one of: a uniform resource identifier of the physical store transaction terminal; a network address of the physical store transaction terminal; a uniform resource identifier of a server that serves the physical store transaction terminal; and a network address of a server that serves the physical store transaction terminal.

71. The system of embodiment 69 wherein the mobile device receives the TID from the physical store transaction terminal or from a physical store entity other than the transaction terminal.

72. The system of embodiment 69 wherein the mobile device receives the TID by scanning a bar code or QR code that encodes the TID.

73. The system of embodiment 72 wherein the bar code or QR code is presented to the mobile device by at least one of the physical store transaction terminal and the physical store entity other than the transaction terminal and wherein the mobile device decodes the bar code or QR code to extract the TID.

74. The system of embodiment 69 wherein the mobile device receives the TID by receiving the TID electronically via a wired or wireless communication protocol.

75. The system of embodiment 74 wherein receiving the TID electronically via a wireless communication protocol includes receiving the TID using near field communication (NFC), Bluetooth, Wi-Fi, Wi-Fi Direct, or cellular communication.

76. The system of embodiment 69 wherein the mobile device receives the TID by detecting or recording a media file that encodes the TID into a media format and wherein the mobile device decodes the media file to extract the TID.

77. The system of embodiment 60 wherein, prior to sending approval from the user to perform the desired transaction, the mobile device authenticates the user.

78. The system of embodiment 77 wherein the mobile device authenticate the user by receiving identification information for identifying the user and authentication information for authenticating the identity of the user, and using the authentication information to authenticate the identity of the user.

79. The system of embodiment 78 wherein the information for identifying or authenticating the identity of the user includes at least one of: a name of the user; an address of the user; an identification number associated with the user; biometric information provided by the user; a password, passcode, or personal information number (PIN) of the user; a digital signature of the user, a geo-location of the user, or information from the user's social network.

80. The system of embodiment 77 wherein authentication of the identity of the user is performed by the mobile device.

81. The system of embodiment 77 wherein the mobile device sends the authentication and identification information to the mobile backend server, which uses the received information to authenticate the user.

82. The system of embodiment 78 wherein the identification or authentication information is provided by the user or by entity different from the user.

83. A system for merchants to provide users with an incentive to use a merchant-preferred payment type for ecommerce transactions, the system comprising a database for storing and maintaining payment information for mobile users and a mobile backend server for: storing, in the database, information that associates a mobile user with payment information for that user, the payment information including a payment type, information that associates a merchant with a list of payment types supported by that merchant, and information that identifies a merchant preference for payment types; and receiving a request for payment information, the request including information identifying a mobile user and information identifying a merchant, and, in response to receiving the request, using the information identifying a mobile user and the information identifying the merchant to determine payment types supported by both the mobile user and the merchant and providing to the user an incentive to use a payment type that is preferred by the merchant.

84. The system of embodiment 83 wherein the mobile backend server receives, from the mobile user, a payment type selection, determines payment information associated with the selected payment type, and initiates an ecommerce transaction using the determined payment information.

85. The system of embodiment 83 wherein the incentive provided to the user by the mobile backend server varies according to payment type.

86. The system of embodiment 85 wherein the incentive provided to the user by the mobile backend server is larger for more-preferred payment types and smaller for less-preferred payment type.

87. The system of embodiment 83, wherein the mobile backend server stores information that indicates the mobile user's class or tier for a particular merchant.

88. The system of embodiment 87 wherein the incentive provided to the user by the mobile backend server varies according to the user's class or tier.

89. The system of embodiment 83 wherein the mobile backend server provides an incentive to use a merchant-preferred payment type by providing a discount to the user for using a merchant-preferred payment type.

90. The system of embodiment 89 wherein providing a discount to the user includes providing to the user a coupon, which the user redeems to receive the discount.

91. The system of embodiment 90 wherein at least one of providing the coupon and redeeming the coupon is performed electronically using a mobile device of the user.

92. The system of embodiment 83 wherein the incentive provided to the user by the mobile backend server varies according to a specific item, product, or product type purchased.

93. The system of embodiment 83 wherein the incentive provided to the user by the mobile backend server varies according to a total value of the transaction.

94. The system of embodiment 83 wherein the incentive provided to the user by the mobile backend server varies according to the user's profile and/or the user's loyalty status.

95. The system of embodiment 83 wherein the incentive provided to the user by the mobile backend server varies according to the merchant.

96. The system of embodiment 83 wherein the mobile backend server provides the incentive to the user by delivering or displaying the incentive to the user via a mobile device of the user.

97. A non-transitory computer readable medium having stored thereon executable instructions that when executed by the processor of a computer control the computer to perform steps comprising, at a mobile backend server for storing and maintaining payment information for mobile users: receiving, from a mobile user, information associated with a payment card, the information including a billing address and a card security code; performing an authentication only reversible transaction for a nominal amount using an ecommerce format; upon receiving approval for the transaction, storing the information except for the card security code, associating the mobile user to the stored information, and authenticating the combination of the mobile user and the stored information for ecommerce transactions.

98. A non-transitory computer readable medium having stored thereon executable instructions that when executed by the processor of a computer control the computer to perform steps comprising, at a mobile backend server for storing and maintaining payment information for mobile users: receiving, from a mobile device of a user, information identifying a physical store transaction terminal; requesting and receiving, from the identified physical store transaction terminal, information about a transaction desired by the user, the information including an amount of the transaction; forwarding the information about the transaction to the user's mobile device for approval by the user; receiving, from the user's mobile device, approval from the user to perform the desired transaction; and in response to receiving the approval, determining payment information associated with the user, and forwarding at least some of the payment information and at least some of the transaction information to a payment network for initiating the desired transaction.

99. A non-transitory computer readable medium having stored thereon executable instructions that when executed by the processor of a computer control the computer to perform steps comprising, at a mobile backend server for storing and maintaining payment information for mobile users: storing information that associates a mobile user with payment information for that user, the payment information including a payment type; storing information that associates a merchant with a list of payment types supported by that merchant and information that identifies a merchant preference for payment types; receiving a request for payment information, the request including information identifying a mobile user and information identifying a merchant; and, in response to receiving the request, using the information identifying a mobile user and the information identifying the merchant to determine payment types supported by both the mobile user and the merchant and providing to the user an incentive to use a payment type that is preferred by the merchant.

The example embodiments described herein are intended to be illustrative and not limiting. It is important to note that the order of the actions and messages described above are for illustration only and are not intended to be limiting. Furthermore, embodiments having additional steps or fewer steps are also within the scope of the subject matter described herein.

What is claimed is:

1. A method for authenticating a mobile user for ecommerce transactions, the method comprising:
at a mobile backend server for storing and maintaining payment information for mobile users:
receiving, from a mobile user, information associated with a payment card, the information including a billing address and a card security code;
performing an authentication only reversible transaction for a nominal amount using an ecommerce format;
upon receiving approval for the transaction, storing the information except for the card security code, associating the mobile user to the stored information, and authenticating the combination of the mobile user and the stored information for ecommerce transactions.

2. The method of claim 1 comprising, upon receiving approval for the transaction, reversing the transaction.

3. The method of claim 1 comprising receiving information identifying a mobile device used by the mobile user and wherein authenticating the combination of the mobile user and the stored information for ecommerce transactions includes authenticating the combination of the mobile user, the mobile device, and the stored information.

4. The method of claim 1 wherein the mobile user is authenticated for ecommerce transactions involving a specific merchant, for ecommerce transactions using a specific payment type, or a combination of the above.

5. A method for generating and completing an ecommerce transaction at a physical store, the method comprising:
at a mobile backend server for storing and maintaining payment information for mobile users:
receiving, from a mobile device of a user, information identifying a physical store transaction terminal;
requesting and receiving, from the identified physical store transaction terminal, information about a transaction desired by the user, the information including an amount of the transaction;
forwarding the information about the transaction to the user's mobile device for approval by the user;
receiving, from the user's mobile device, approval from the user to perform the desired transaction; and
in response to receiving the approval:
determining payment information associated with the user; and
forwarding at least some of the payment information and at least some of the transaction information to a payment network for initiating the desired ecommerce transaction.

6. The method of claim 5 wherein forwarding at least some of the payment information and at least some of the transaction information to a payment network includes forwarding at least some of the payment information to the physical store transaction terminal and wherein the physical store transaction terminal forwards the received payment information along with at least some of the information about the transaction to the payment network.

7. The method of claim 5 wherein forwarding at least some of the payment information and at least some of the transaction information to a payment network includes sending the payment and transaction information to the payment network directly and not sending that information to the physical store transaction terminal.

8. The method of claim 5 comprising initiating the transaction at the payment network.

9. The method of claim 8 comprising receiving, at the mobile backend server and from the payment network, a result of the initiated transaction.

10. The method of claim 5 wherein the payment information includes information that identifies a financial institution.

11. The method of claim 5 wherein the payment information includes a name of the user or information identifying the user's membership in a loyalty, rewards, or discount program.

12. The method of claim 5 wherein the requested ecommerce transaction comprises at least one of: a payment or purchase; a credit transaction; a debit transaction; a deposit; a withdrawal; a money transfer; a transaction involving a loyalty program; a transaction involving a rewards program; and a transaction involving a diet, health, or fitness program.

13. The method of claim 5 wherein, prior to the mobile backend server receiving the information identifying a physical store transaction terminal from the mobile device, the mobile device receives the information identifying the physical store transaction terminal (TID).

14. The method of claim 13 wherein the TID includes at least one of:
a uniform resource identifier of the physical store transaction terminal;
a network address of the physical store transaction terminal;
a uniform resource identifier of a server that serves the physical store transaction terminal; and
a network address of a server that serves the physical store transaction terminal.

15. The method of claim 13 wherein the mobile device receives the TID from the physical store transaction terminal or from a physical store entity other than the transaction terminal.

16. The method of claim 15 wherein the mobile device receives the TID by scanning a bar code or QR code that encodes the TID.

17. The method of claim 16 wherein the bar code or QR code is presented to the mobile device by at least one of the physical store transaction terminal and the physical store entity other than the transaction terminal and wherein the mobile device decodes the bar code or QR code to extract the TID.

18. The method of claim 15 wherein the mobile device receives the TID by receiving the TID electronically via a wired or wireless communication protocol.

19. The method of claim 18 wherein receiving the TID electronically via a wireless communication protocol includes receiving the TID using near field communication (NFC), Bluetooth, Wi-Fi, Wi-Fi Direct, or cellular communication.

20. The method of claim 15 wherein the mobile device receives the TID by detecting or recording a media file that encodes the TID into a media format and wherein the mobile device decodes the media file to extract the TID.

21. The method of claim 5 comprising, prior to sending approval from the user to perform the desired transaction, authenticating the user by the mobile device.

22. The method of claim 21 wherein authenticating the user by the mobile device includes receiving, at the mobile device, identification information for identifying the user and authentication information for authenticating the identity of the user and using the authentication information to authenticate the identity of the user.

23. The method of claim 22 wherein the information for identifying or authenticating the identity of the user includes at least one of: a name of the user; an address of the user; an identification number associated with the user; biometric information provided by the user; a password, passcode, or personal information number (PIN) of the user; a digital signature of the user, a geo-location of the user, or information from the user's social network.

24. The method of claim 22 wherein authentication of the identity of the user is performed by the mobile device.

25. The method of claim 22 comprising, at the backend mobile server, receiving from the mobile device identification information and authentication information and using the received information to authenticate the user.

26. The method of claim 22 wherein the identification or authentication information is provided by the user or by entity different from the user.

27. The method of claim 5 further comprising performing a reconciliation or settlement by the physical store for the ecommerce transaction.

28. The method of claim 27 wherein the reconciliation or settlement is performed between a retailer backend server that serves the physical store and an ecommerce server that participated in the ecommerce transaction.

29. A method for merchants to provide users with an incentive to use a merchant-preferred payment type for ecommerce transactions, the method comprising:
at a mobile backend server for storing and maintaining payment information for mobile users:
storing information that associates a mobile user with payment information for that user, the payment information including a payment type;
storing information that associates a merchant with a list of payment types supported by that merchant and information that identifies a merchant preference for payment types;
receiving a request for payment information, the request including information identifying a mobile user and information identifying a merchant; and
in response to receiving the request, using the information identifying a mobile user and the information identifying the merchant to determine payment types supported by both the mobile user and the merchant and providing to the user an incentive to use a payment type that is preferred by the merchant.

30. The method of claim 29 comprising:
receiving, from the mobile user, a payment type selection;
determining payment information associated with the selected payment type; and
initiating an ecommerce transaction using the determined payment information.

31. A system for authenticating a mobile device for ecommerce transactions, the system comprising:
a database for storing and maintaining payment information for mobile users; and
a mobile backend server that receives, from a mobile user, information associated with a payment card, the information including a billing address and a card security code; that performs an authentication only reversible transaction for a nominal amount using an ecommerce format; and that, upon receiving approval for the transaction, stores the information except for the card security code into the database, associates the mobile user to the stored information, and authenticates the combination of the mobile user and the stored information for ecommerce transactions.

32. The system of claim 31 wherein, upon receiving approval for the transaction, the mobile backend server reverses the transaction.

33. A system for generating and completing an ecommerce transaction at a physical store, the system comprising:
a database for storing and maintaining payment information for mobile users; and
a mobile backend server that receives, from a mobile device of a user, information identifying a physical store transaction terminal; that requests and receives from the identified physical store transaction terminal, information about a transaction desired by the user, the information including an amount of the transaction; that forwards the information about the transaction to the user's mobile device for approval by the user; that receives, from the user's mobile device, approval from the user to perform the desired transaction; and that, in response to receiving the approval, retrieves from the database payment information associated with the user and forwards at least some of the payment information to a payment network for initiating the desired ecommerce transaction.

34. The system of claim 33 wherein the mobile backend server forwards the at least some of the payment information to the physical store transaction terminal and wherein the physical store transaction terminal forwards the received payment information along with at least some of the information about the transaction to the payment network.

35. The system of claim 33 wherein the mobile backend server forwards the at least some of the payment information along with at least some of the transaction information to a payment network directly without sending that information to the physical store transaction terminal.

36. The system of claim 33 wherein the payment information includes information that identifies a financial institution.

37. The system of claim 33 wherein the payment information includes a name of the user or information identifying the user's membership in a loyalty, rewards, or discount program.

38. The system of claim 33 wherein the requested ecommerce transaction comprises at least one of: a payment or purchase; a credit transaction; a debit transaction; a deposit; a withdrawal; a money transfer; a transaction involving a loyalty program; a transaction involving a rewards program; and a transaction involving a diet, health, or fitness program.

39. The system of claim 33 wherein, prior to receiving the information identifying a physical store transaction terminal from the mobile device, the mobile device receives the information identifying the physical store transaction terminal (TID).

40. The system of claim 39 wherein the TID includes at least one of:
a uniform resource identifier of the physical store transaction terminal;
a network address of the physical store transaction terminal;
a uniform resource identifier of a server that serves the physical store transaction terminal; and
a network address of a server that serves the physical store transaction terminal.

41. The system of claim 39 wherein the mobile device receives the TID from the physical store transaction terminal or from a physical store entity other than the transaction terminal.

42. The system of claim 39 wherein the mobile device receives the TID by scanning a bar code or QR code that encodes the TID.

43. The system of claim 42 wherein the bar code or QR code is presented to the mobile device by at least one of the physical store transaction terminal and the physical store entity other than the transaction terminal and wherein the mobile device decodes the bar code or QR code to extract the TID.

44. The system of claim 39 wherein the mobile device receives the TID by receiving the TID electronically via a wired or wireless communication protocol.

45. The system of claim 44 wherein receiving the TID electronically via a wireless communication protocol includes receiving the TID using near field communication (NFC), Bluetooth, Wi-Fi, Wi-Fi Direct, or cellular communication.

46. The system of claim 39 wherein the mobile device receives the TID by detecting or recording a media file that encodes the TID into a media format and wherein the mobile device decodes the media file to extract the TID.

47. The system of claim 33 wherein, prior to sending approval from the user to perform the desired transaction, the mobile device authenticates the user.

48. The system of claim 47 wherein the mobile device authenticates the user by receiving identification information for identifying the user and authentication information for authenticating the identity of the user, and using the authentication information to authenticate the identity of the user.

49. The system of claim 48 wherein the information for identifying or authenticating the identity of the user includes at least one of: a name of the user; an address of the user; an identification number associated with the user; biometric information provided by the user; a password, passcode, or personal information number (PIN) of the user; a digital signature of the user, a geo-location of the user, or information from the user's social network.

50. The system of claim 47 wherein authentication of the identity of the user is performed by the mobile device.

51. The system of claim 47 wherein the mobile device sends the authentication and identification information to the mobile backend server, which uses the received information to authenticate the user.

52. The system of claim 48 wherein the identification or authentication information is provided by the user or by entity different from the user.

53. A system for merchants to provide users with an incentive to use a merchant-preferred payment type for ecommerce transactions, the system comprising:
a database for storing and maintaining payment information for mobile users; and
a mobile backend server for:
storing, in the database, information that associates a mobile user with payment information for that user, the payment information including a payment type, information that associates a merchant with a list of payment types supported by that merchant, and information that identifies a merchant preference for payment types; and
receiving a request for payment information, the request including information identifying a mobile user and information identifying a merchant, and, in response to receiving the request, using the information identifying a mobile user and the information identifying the merchant to determine payment types supported by both the mobile user and the merchant and providing to the user an incentive to use a payment type that is preferred by the merchant.

54. The system of claim 53 wherein the mobile backend server receives, from the mobile user, a payment type selection, determines payment information associated with the selected payment type, and initiates an ecommerce transaction using the determined payment information.

55. A non-transitory computer readable medium having stored thereon executable instructions that when executed by the processor of a computer control the computer to perform steps comprising:
at a mobile backend server for storing and maintaining payment information for mobile users:
receiving, from a mobile user, information associated with a payment card, the information including a billing address and a card security code;
performing an authentication only reversible transaction for a nominal amount using an ecommerce format;
upon receiving approval for the transaction, storing the information except for the card security code, associating the mobile user to the stored information, and authenticating the combination of the mobile user and the stored information for ecommerce transactions.

56. A non-transitory computer readable medium having stored thereon executable instructions that when executed by the processor of a computer control the computer to perform steps comprising:
at a mobile backend server for storing and maintaining payment information for mobile users:
receiving, from a mobile device of a user, information identifying a physical store transaction terminal;
requesting and receiving, from the identified physical store transaction terminal, information about a transaction desired by the user, the information including an amount of the transaction;
forwarding the information about the transaction to the user's mobile device for approval by the user;
receiving, from the user's mobile device, approval from the user to perform the desired transaction; and
in response to receiving the approval:
determining payment information associated with the user; and
forwarding at least some of the payment information and at least some of the transaction information to a payment network for initiating the desired ecommerce transaction.

57. A non-transitory computer readable medium having stored thereon executable instructions that when executed by the processor of a computer control the computer to perform steps comprising:
at a mobile backend server for storing and maintaining payment information for mobile users:
storing information that associates a mobile user with payment information for that user, the payment information including a payment type;
storing information that associates a merchant with a list of payment types supported by that merchant and information that identifies a merchant preference for payment types;
receiving a request for payment information, the request including information identifying a mobile user and information identifying a merchant; and
in response to receiving the request, using the information identifying a mobile user and the information identifying the merchant to determine payment types supported by both the mobile user and the merchant and providing to the user an incentive to use a payment type that is preferred by the merchant.
